(19) United States
(12) Patent Application Publication
(10) Pub. No.: US 2009/0189433 A1
(43) Pub. Date: Jul. 30, 2009

(54) MODULAR SCHOOL BUS SEATS

(75) Inventors: Erik C. Wilson, Decatur, IN (US); Alan D. Osteril, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/019,707

(22) Filed: Jan. 25, 2008

(51) Int. Cl. B60N 2/24

(52) U.S. Cl. 297/440.14

(57) ABSTRACT

A modular seat frame for a school bus seat based on a minimized number of components and allowing for different orders of assembly.

### BACKGROUND OF THE INVENTION

1. Technical Field

The present invention relates to school bus seats and more particularly to a modular school bus seat frame characterized by differentiated sub-assembly possibilities to ease of installation on a bus and readily modified to meet differing configuration requirements by customers all with a minimized number of differing parts.

2. Description of the Problem

School bus seats are built to meet many differing customer specifications. For example, some bus seats must accommodate three point safety belts by providing a compatible upper back rest, other specifications call for a universal child restraint attachment equipped lower frame, while still others provide standard DOT (United States Department of Transportation) seat backs. At the same time customers can specify seats in different widths or heights and can demand various strength requirements.

Differing customers' specifications have required substantially or entirely different component sets. The need to supply such component sets has even occurred in relation to completed vehicles that have been put into service, particularly when the vehicle has been moved from one state or municipality to another due to differing requirements of the new jurisdiction.

Modular construction of bus seat frames is known, one example being taught in U.S. Pat. No. 6,886,889 to Vits et al. FIGS. 18-20 of the Vits '889 patent teach a modular seat based on four major sub-assemblies. The sub-assemblies include a frame assembly, a floor mount assembly, a passive restraint panel and a seat member. The frame assembly in turn comprises a pair of opposed side forms which are generally elbow shaped and concave in construction, two upright members or posts which support the passive restraint panel, longitudinal front and rear members for mounting between the opposed side forms and cross members between the front and rear members. The frame assembly is supported by a pair of identical pedestals, which are collectively termed the floor mount assembly even though they are not directly connected, and which are disposed under the respective side forms. In some embodiments one of the pedestals is replaced by a wall mount bracket shown in FIGS. 26 and 27 of the patent.

### SUMMARY OF THE INVENTION

It is an object of the invention to provide a modular bus seat frame with sub-assemblies exhibiting flexible constituent elements.

It is a further object of the invention to provide a modular bus seat which minimizes the number of changes in components to meet differing seat specifications.

The invention provides a modular seat assembly for school busses. The seat assembly includes an aisle riser including a support neck, a wall riser including a support neck, a front cross support fitted between the aisle riser and the wall riser, a rear cross support fitted between the aisle riser and the wall riser, a perimeter tube fitted at opposite ends to the support necks of the aisle riser and the wall riser, respectively, and a back panel supported within the perimeter tube behind and above the rear cross support.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view of a school bus.

FIG. 2 is a perspective view of a prior art school bus seat frame.

FIG. 3 is a perspective view of a modular school bus seat frame in accordance with a preferred embodiment of the invention installed in a vehicle.

FIG. 4 is an exploded view of an embodiment of the school bus seat frame illustrated in FIG. 3.

FIG. 5 is a perspective view illustrating possible sub-assemblies for the school bus seat frame.

FIG. 6 is a perspective view of a possible alternative set of partial assemblies for the school bus seat frame.

### DETAILED DESCRIPTION OF THE INVENTION

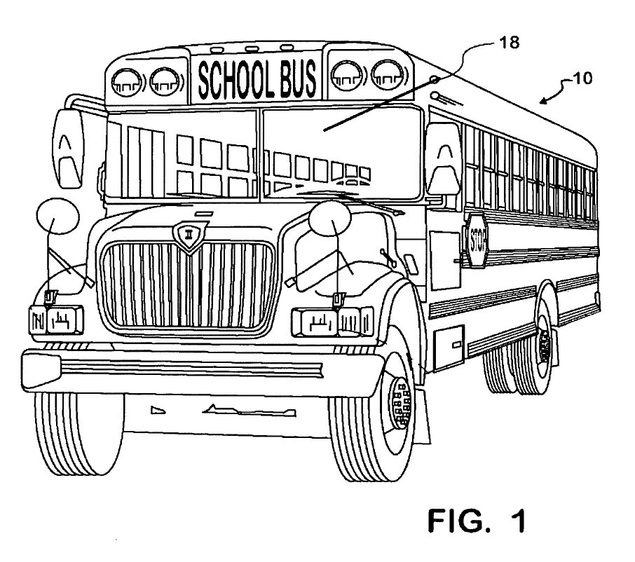

Referring now to the drawings and in particular to FIG. 1, a school bus 10 with which the present invention is advantageously used is illustrated. The seat frames of the present invention are installed in the interior 18 of the bus.

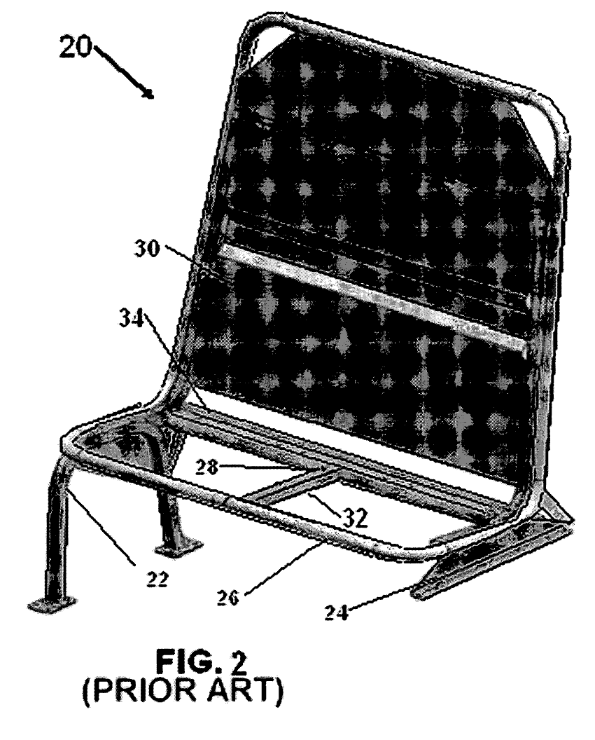

FIG. 2 illustrates a prior art seat frame 20. Seat frame 20 includes a closed-loop, multi-piece full perimeter tube 26. Perimeter tube 26 is shaped in the form of a deep “L” following the perimeter of the seat bottom and seat back for the bus seat frame 20. The perimeter tube 26 is supported by an aisle riser 22 and a wall riser 24. An internal frame 28 and a back seat support 30 are nestled within the closed perimeter tube 26. Internal frame 28 parallels portions of the perimeter tube 26, reinforcing the sides of the perimeter tube and adding a seat back bottom brace 34 and a cross member 32 to give the frame 20 rigidity. Excluding the risers 22, 24, virtually none of the components are reusable should seat specifications, such as width, or height of the seat back be changed.

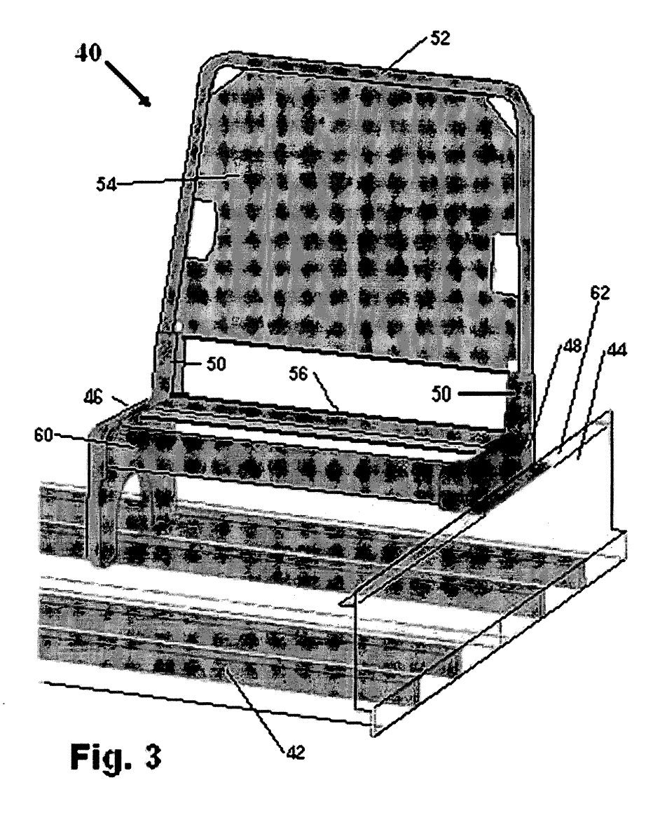

Referring to FIG. 3, an assembled modular school bus seat frame 40 is illustrated disposed on the floor 42 (shown in phantom). Modular frame 40 is supported on its inside end from a chair rail 62 of a school bus interior wall 44 (shown in phantom). Modular school bus seat frame 40 is supported both from the floor 42 and from the wall 44. Support from the floor 42 is provided by an aisle riser 46. Support from the wall 44 is provided by a wall riser 48. Aisle riser 46 and wall riser 48 differ from the aisle risers and floor risers known from the art in that they form part of what would traditionally be considered the frame itself. Both the aisle riser 46 and the wall riser 48 are modified to function as frame elements, in part by inclusion of necks 50 which provide bases of support for an open, partial perimeter tube 52 used to define the top and sides of a seat back portion of frame 40. The partial perimeter tube 52 is a C shaped member mounted at opposite ends in necks 50 which defines the top and sides of the seat back. Suspended on and within the partial perimeter tube 52 is a seat back panel 54. Extending between and fitted into the aisle riser 46 and the wall riser 48 are front and back latitudinal supports 60 and 56. Supports 56 and 60 come in varying lengths to support seats of varying widths. Risers 46 and 48 are molded elements with interior (i.e. facing) sides which are contoured to reinforce the riser. Mounting plates are used set in the risers to provide points of attachment for the front and back latitudinal supports 56, 60 fit.

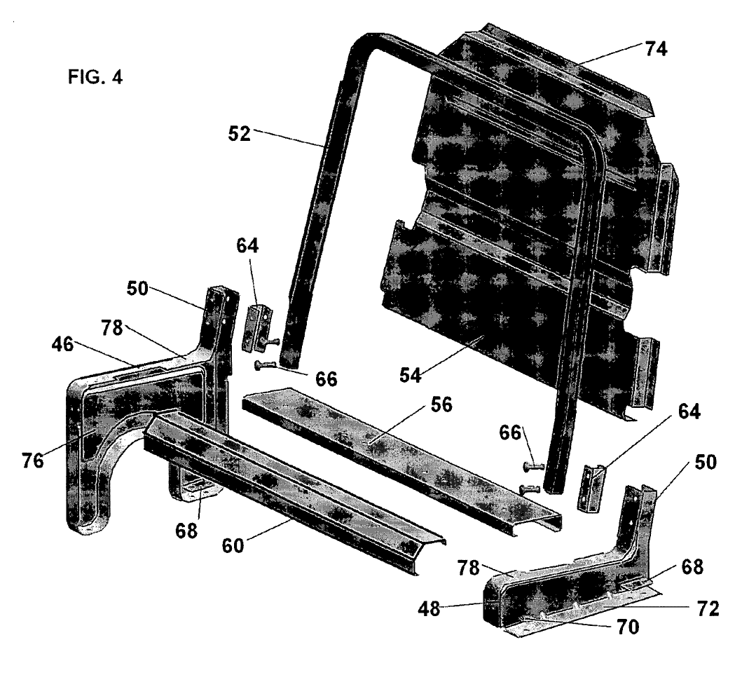

FIG. 4 illustrates the modular seat frame 40 in an exploded view. Necks 50 are formed from C-channel sections extending upwardly from the upper rearward areas of aisle riser 46 and wall riser 48. The channels are open one with respect to the other. Open perimeter tube 52 fits into the necks 50 at its opposite ends. The joint formed by joining the ends of the perimeter tube 52 to the necks 50 is reinforced by addition of an U-reinforcement member 64 which fits into the neck 50 between the tube 52 and the interior of the necks 50. Bolts 66 are inserted through the walls of the necks 50, U-reinforcement members 64 and the ends of perimeter tube 52.

Back panel 54 includes a partial perimeter lip 74 by which the panel is attached to tube 52. Risers 46, 48 include inner face contours 76 which position the ends of rear and front cross supports 56, 60, which leave wells between an upper, inwardly turned flanges 78. Cross supports 56, 60 may have different cross sectional shapes along as the ends of the members fit the risers 46, 48 to allow construction of a joint. The major members of the assembly/sub-assemblies may be attached to one another using self piercing rivets, adhesives or welds. Aisle riser 46 includes legs which support the structure from the floor. A plate 68 is provided for securing fasteners between the riser 46 and a vehicle floor. Wall riser 48 includes an attachment flange 72 allowing securing of the wall riser to a wall support. Plate 68 and washer 70 are provided as part of the attachment process.

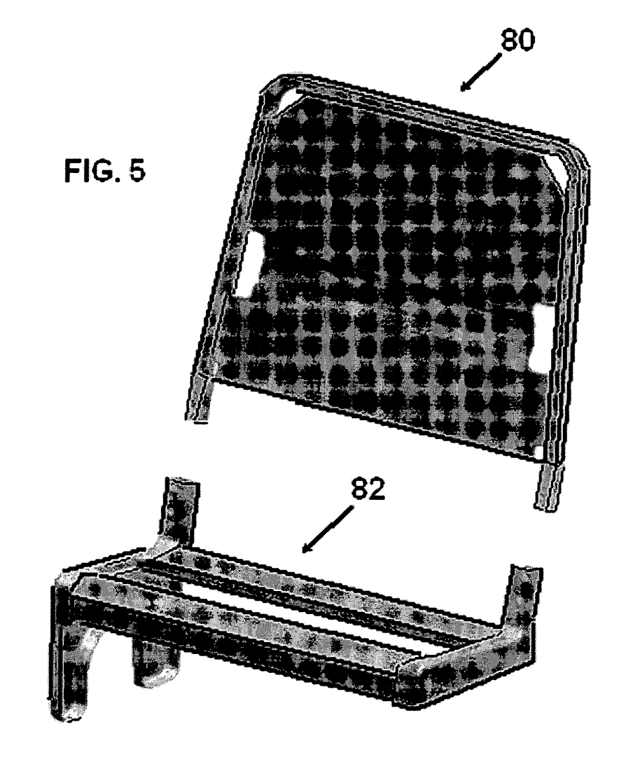

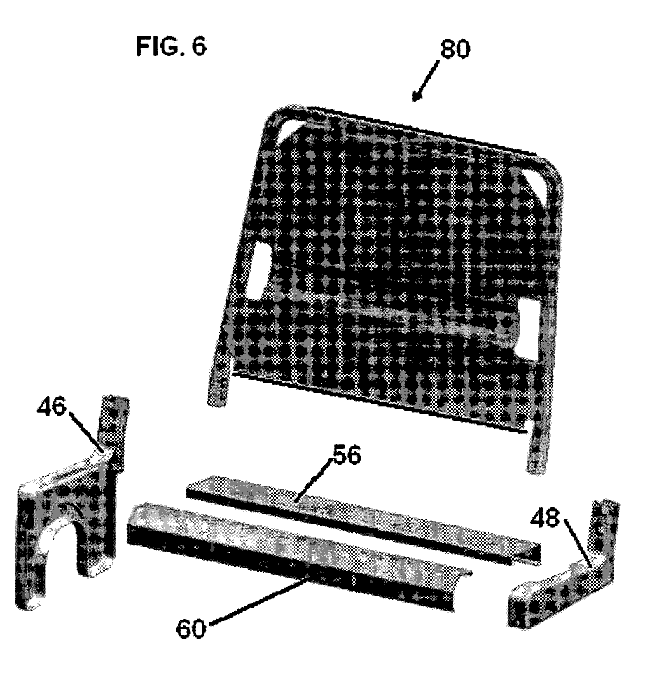

FIGS. 5 and 6 illustrate alternative partial fabrications of the modular seat frame, the system of FIG. 5 providing for delivery for installation in two sections or sub-assemblies 80, 82. Sub-assembly 80 includes perimeter tube 52, its reinforcing braces and back seat support 54. Sub-assembly 82 comprises risers 46 and 48 and the longitudinal braces 56 and 60.

FIG. 6 illustrates a division of frame into a section 80, as described above, and the two risers 46, 48 and the two braces 56, 60. The divisions of the frame illustrate that the frame can be constructed from its constituent parts or from sub-assemblies in virtually any order.

As typically assembled the preferred embodiment of the seat frame uses MIG welds instead of self-pierce rivets, adhesives or spot welds. The total length of welds has been reduced in length from about 62 inches for the seat frame of FIG. 2 to about 24 inches in the present preferred embodiment, and it is possible to reduce even this level if rivets are used.

While the invention is shown in only one of its forms, it is not thus limited but is susceptible to various changes and modifications without departing from the spirit and scope of the invention.

What is claimed is:

1. A modular seat frame for installation on a school bus comprising:
an aisle riser;
a wall riser;
a front cross support fitted between the aisle riser and the wall riser;
a rear cross support fitted between the aisle riser and the wall riser;
a partial perimeter tube fitted supported at opposite ends from the aisle riser and the wall riser, respectively, to provide a back panel support frame; and
a back panel supported within the perimeter tube behind and above the rear cross support.

2. A modular seat frame as claimed in claim 1, further comprising:
the aisle riser and the wall riser each incorporating support necks at one end; and
the partial perimeter tube being mounted at respective ends to the support necks.

3. A modular seat frame as claimed in claim 2, the aisle riser, the wall riser, the cross supports and the partial perimeter tube allowing assembly in a plurality of orders.

4. Modular seat frame constituent sub-assemblies for use in constructing a seat frame, comprising:
a first sub-assembly comprising a partial perimeter tube and a back panel suspended within the partial perimeter tube.

5. Modular seat frame constituent sub-assemblies for use in constructing a seat frame as set forth in claim 5, further comprising:
a second sub-assembly comprising a wall riser, a floor riser and front and rear cross supports mounted between the wall and floor risers.
